(19) United States
(12) Patent Application Publication
(10) Pub. No.: US 2005/0190270 A1
(43) Pub. Date: Sep. 1, 2005

(54) Method and apparatus for processing image signal

(76) Inventor: Hyun-Sang Park, Cheonan-Si (KR)

Correspondence Address: LAW OFFICE OF MONICA H CHOI, P O BOX 3424, DUBLIN, OH, 430160204, US

(21) Appl. No.: 11/003,076

(22) Filed: Dec. 2, 2004

(30) Foreign Application Priority Data
Feb. 26, 2004 (KR) 2004-0013008

(51) Int. Cl. H04N 5/228

(52) U.S. Cl. 348/222.1

(57) ABSTRACT

For processing at least one image signal, a scaler generates display data corresponding to the image signal. The display data is synchronized to at least one timing signal having active intervals and blanking intervals. A data compressor generates compressed data corresponding to the image signal. A data formatter is coupled to the scaler and the data compressor, and outputs the compressed data during the blanking intervals and the display data during the active intervals.

### BACKGROUND OF THE INVENTION

This application claims priority to Korean Patent Application Ser. No. 2004-0013008, filed on Feb. 26, 2004, in the Korean Intellectual Property Office, the disclosure of which is incorporated herein in its entirety by reference.

1. Field of the Invention

The present invention relates generally to processing an image signal, and more particularly to outputting compressed data of the image signal during blanking intervals for display data of the image signal.

2. Description of the Related Art

FIG. 1 is a block diagram of a conventional image signal processing apparatus 100. Referring to FIG. 1, the conventional image signal processing apparatus 100 includes a solid-state image sensing device 110, an image signal processor 120, a data compressor 130, and a resolution converter 140.

The solid-state image sensing device is of a CIS (CMOS Image Sensor) type or a CCD (Charge Coupled Device) type, for example. The solid state sensing device 110 is included in a camera for a mobile phone or a digital still camera, for example. The solid-state sensing device 110 is implemented as an APS (active pixel sensor) array of a million or more pixels for high resolution.

The solid-state sensing device 110 captures an image to generate digital color image signals (Red, Green, Blue) using a respective photodiode for each pixel of the APS array. A general color solid-state sensing device 110 includes color filters of three types, with each color filter mounted over a respective pixel to form a Bayer color pattern for the APS array. Each color filter transmits only light of a specific respective color. Thus, the digital image signals (R, G, B) from the solid-state sensing device 110 represent the Bayer pattern of the APS array 110.

The image signal processor 120 processes the digital image signals (R, G, B) to generate image-processed signals including a brightness signal (Y) and chroma signals (Cb, Cr) according to a predetermined standard. Such image-processed signals Y, Cb, and Cr are then processed by the resolution converter 140 that drives a display device such as a LCD (Liquid Crystal Display).

On the other hand, the data compressor 130 compresses such image-processed signals Y, Cb, and Cr according to the JPEG (Joint Photographic Expert Group) or MPEG (Moving Picture Experts Group) standard. The compressed data is typically photo data capable of being shown on a display device. Such compressed data is also typically stored in a predetermined memory device under control of a predetermined controller (not shown).

In such a conventional image signal processing apparatus 100, the solid state image sensing device 110, the image signal processor 120, the data compressor 130, and the resolution converter 140 are fabricated as separate chips, or only the solid-state image sensing device 110 and the image signal processor 120 are fabricated together as a single chip. Also, while compressed data from the data compressor 130 is stored into the predetermined memory, display data from the resolution converter 140 is not output to the display device, so that a currently captured image cannot be displayed.

### SUMMARY OF THE INVENTION

In a method and apparatus for processing at least one image signal according to a general aspect of the present invention, a scaler generates display data corresponding to the image signal. The display data is synchronized to at least one timing signal having active intervals and blanking intervals. In addition, a data compressor generates compressed data corresponding to the image signal. Furthermore, a data formatter is coupled to the scaler and the data compressor, and outputs the compressed data during the blanking intervals.

In another embodiment of the present invention, the data formatter outputs the display data during the active intervals.

In a further embodiment of the present invention, an image signal processor generates, from the image signal, image-processed signals including a brightness (Y) signal and chroma (Cb, Cr) signals. The image signal processor also generates a horizontal synchronization signal and a vertical synchronization signal. In that case, the data formatter outputs the compressed data during a blanking interval of at least one of the horizontal and vertical synchronization signals. In addition, the scaler generates the display data by sampling the image-processed signals.

In yet another embodiment of the present invention, the data compressor includes a JPEG encoder and an MPEG encoder to compress the image-processed signals according to a selected one of a JPEG or MPEG standard to generate the compressed data.

In a further embodiment of the present invention, a line memory stores the compressed data, and a blanking signal generator activates a blanking signal during the blanking intervals. The data formatter outputs the compressed data stored in the line memory when the blanking signal is activated.

In another aspect of the present invention, an IC (integrated circuit) die has fabricated therein the above-described components for processing the image signal.

In this manner, the method and apparatus for processing the image signal according to the present invention outputs compressed data and display data. The compressed data is generated simultaneously with the display data and is stored in the line memory. Thereafter, the compressed data is output during the blanking intervals for the display data to save time for outputting the compressed and display data related to the image signal. In addition, the components for generating and outputting such compressed and display data are fabricated as a single IC die for being incorporated into small portable electronic devices.

### BRIEF DESCRIPTION OF THE DRAWINGS

The above and other features and advantages of the present invention will become more apparent when described as detailed exemplary embodiments thereof with reference to the attached drawings in which:

FIG. 1 is a block diagram of a conventional image signal processing apparatus;

FIG. 2 is a block diagram of an image signal processing apparatus according to an embodiment of the present invention;

FIG. 3 is a flowchart of steps during operation of the image signal processing apparatus of FIG. 2, according to an embodiment of the present invention;

FIG. 4 is a timing diagram illustrating compressed data that is output during blanking intervals for display data, according to an embodiment of the present invention;

FIGS. 5A and 5B each show an example circuit of a blanking signal generator that activates a blanking signal for outputting compressed data, according to an embodiment of the present invention; and

FIG. 6 shows a block diagram illustrating the components of the image signal processing apparatus of FIG. 2 being fabricated within an IC (integrated circuit) die, according to an embodiment of the present invention.

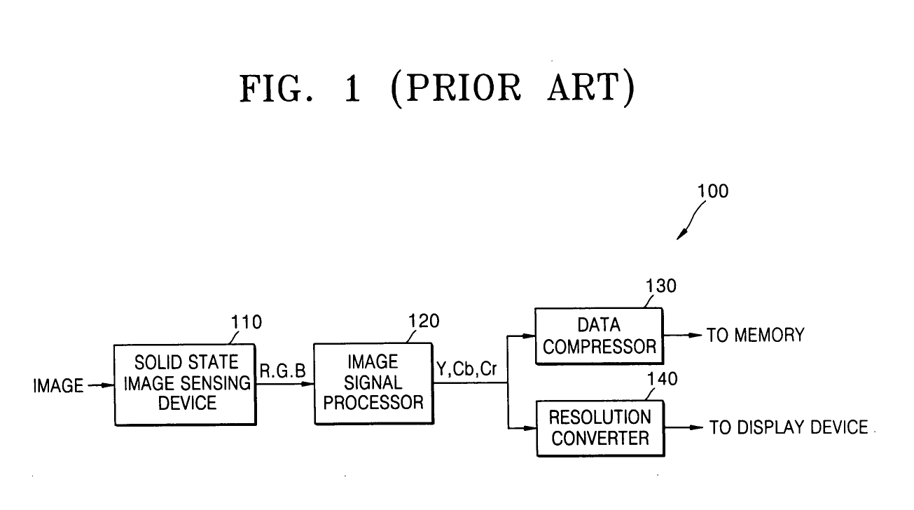

The figures referred to herein are drawn for clarity of illustration and are not necessarily drawn to scale. Elements having the same reference number in FIGS. 1, 2, 3, 4, 5A, 5B, and 6 refer to elements having similar structure and function.

### DETAILED DESCRIPTION OF THE INVENTION

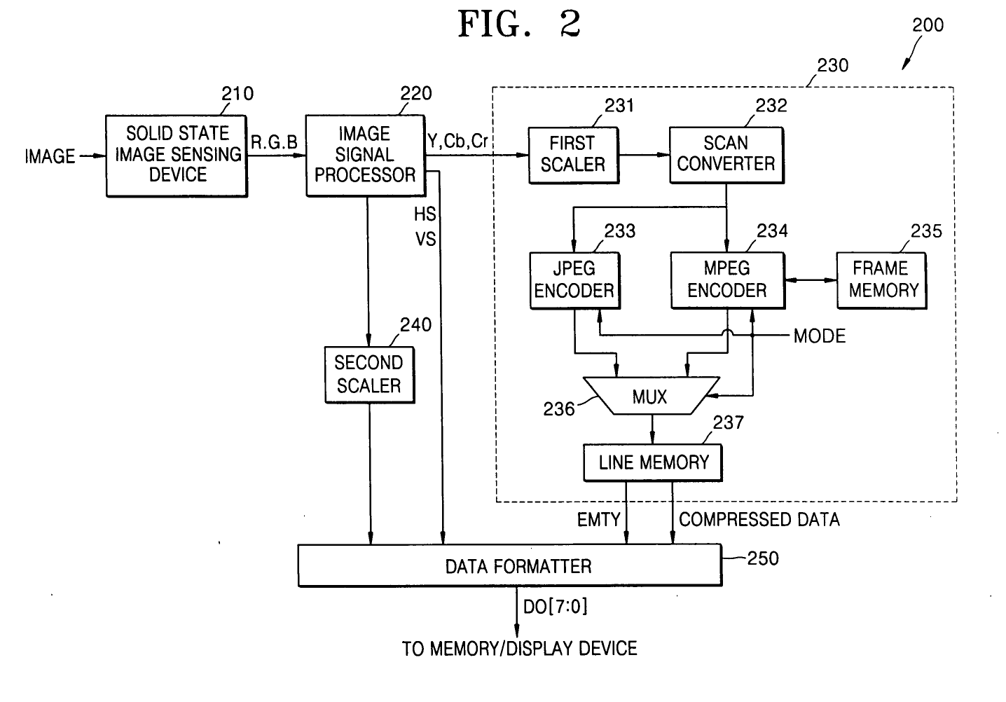

FIG. 2 is a block diagram of an image signal processing apparatus 200 according to an embodiment of the present invention. Referring to FIG. 2, the image signal processing apparatus 200 includes a solid state image sensing device 210, an image signal processor 220, a data compressor 230, a second scaler 240, and a data formatter 250.

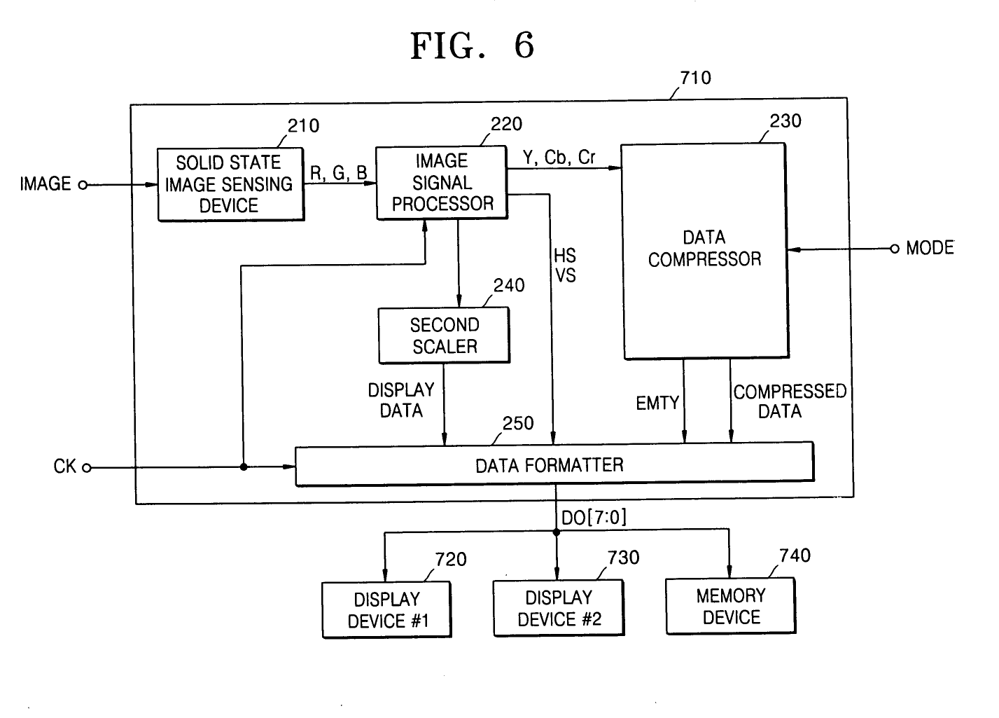

In one embodiment of the present invention, referring to FIGS. 2 and 6, the components of the image signal processing apparatus 200 are fabrication on a single IC (integrated circuit) die 710 for being included in a small portable electronic device such as in a camera for a mobile phone, a digital still camera, etc. The solid state image sensing device 210 is implemented as an APS (active pixel sensor) array of a million or more pixels for relatively high resolution.

The solid-state sensing device 210 captures an image to generate digital color image signals (Red, Green, Blue) corresponding to the captured image. A respective photodiode is located at each pixel of the APS array 210. For a general color solid-state sensing device 210, color filters of three types are mounted in a Bayer color pattern over the APS array 210. Each of the color filters transmits only light of a specific color and is disposed at a respective pixel of the APS array 210. The respective color for such color filters is arranged in the Bayer color pattern over the APS array 210. Thus, the digital image signals (R, G, B) are generated from the solid-state sensing device 210 with the Bayer color pattern.

The image signal processor 220 interpolates the digital image signals (R, G, B) and performs additional functions such as Γ correction, edge enhancement, AE (auto exposure)/AWB (auto white balance) control, and digital zoom to the digital image signals (R, G, B), for example, thereby generating image-processed signals (Y, Cb, Cr). Such additional functions and such interpolation of the digital image signals (R, G, B) to generate the image-processed signals (Y, Cb, Cr) individually are known to one of ordinary skill in the art.

Such image-processed signals (Y, Cb, Cr) include a brightness signal (Y) and chroma signals (Cb, Cr) defined by the NTSC (National Television System Committee) or PAL (Phase Alternation by Line system) standard, for example. In one example embodiment, the image-processed signals (Y, Cb, Cr) are output with a chroma format of 4:2:2 with an order of . . . , Y, Cb, Y, Cr, Y, Cb, Y, Cr . . . . The image signal processor 220 also generates a horizontal synchronization signal HS and/or a vertical synchronization signal VS to be further described herein.

The second scaler 240 generates display data for driving a display device (720 of FIG. 6) such as a LCD (Liquid Crystal Display), from the image-processed signals (Y, Cb, Cr). The second scaler 240 samples the image-processed signals (Y, Cb, Cr) to generate the display data corresponding to a display resolution selected automatically or by a user.

Such display data generated by sampling the image-processed signals (Y, Cb, Cr) is generally of low resolution that is advantageous when high resolution display is not required. For example, when previewing an image to be captured or during an auto focusing process, the second scaler 240 reduces the resolution for the display data for faster data processing. Alternatively, if the user wants to maintain the original high resolution, the second scaler 240 may be set to just output the image-processed signals (Y, Cb, Cr) as the display data.

The data compressor 230 compresses the image-processed signals (Y, Cb, Cr) to generate compressed data. The data formatter 250 outputs the compressed data within blanking intervals of the timing signals HS and VS for the display data, in an embodiment of the present invention as will be further described herein.

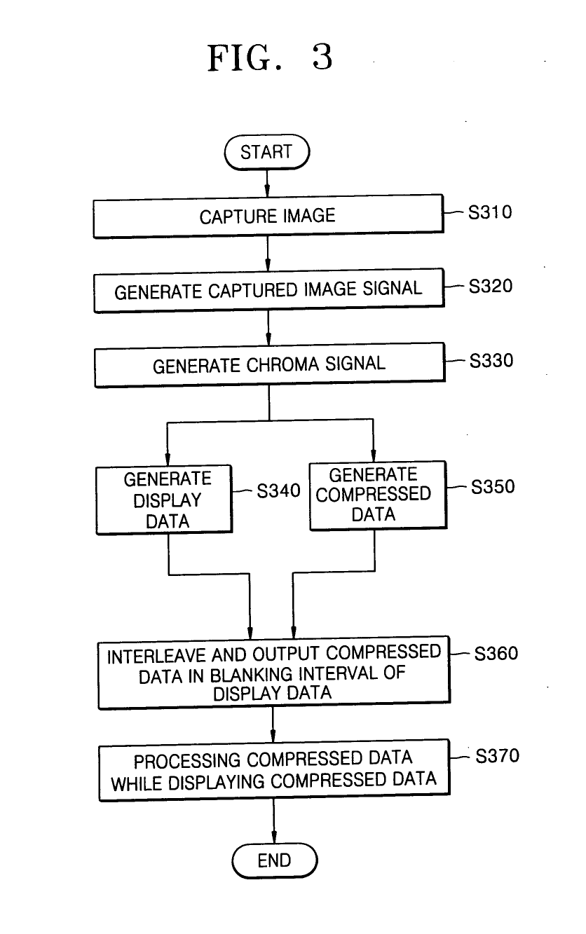

FIG. 3 shows a flowchart of steps during operation of the image signal processing apparatus of FIG. 2. Referring to FIGS. 2 and 3, when a mechanical shutter is opened, an image is photo-electrically converted during a predetermined time by photo-diodes of the APS array of the solid state image sensing device 210 (step S310 of FIG. 3). The photo-diodes of each horizontal line of the APS array 210 generate an analog image signal that is digitized to generate digital image signals (R, G, B) (step S320 of FIG. 3).

Thereafter, the image signal processor 220 interpolates the digital image signals (R, G, B) (with above-described additional image processing functions) to generate the image-processed signals (Y, Cb, Cr) including a brightness signal (Y) and chroma signals (Cb, Cr) (step S330 of FIG. 3). The image signal processor 220 also generates a horizontal synchronization signal HS and a vertical synchronization signal VS.

Subsequently, the second scaler 240 generates display data for driving a display device (720 of FIG. 6) such as a LCD by sampling the image-processed signals (Y, Cb, Cr) (step S340 of FIG. 3). Also, the data compressor 230 compresses the image-processed signals (Y, Cb, Cr) to generate the compressed data (step S350 of FIG. 3).

Referring to FIGS. 2 and 3, the data compressor 230 compresses the image-processed signals (Y, Cb, Cr) in a mode (still image mode or moving-image mode) selected by a user. The data compressor 230 samples the image-processed signals (Y, Cb, Cr) with a respective resolution or compression rate indicated automatically or by a user through the first scaler 231.

The scan converter 232 converts the sampled signal into MCUs (minimum coding units) or predetermined macro blocks with a raster scan order indicated by the first scaler 231. Such MCUs or marco blocks are capable of being processed by the JPEG (Joint Photographic Expert Group) encoder 233 or the MPEG (Moving Picture Experts Group) encoder 234.

For example, a data stream of a macro block unit corresponding to an 8633 8 matrix of the APS array 210 is used for encoding by the JPEG encoder 233 during compression for the still-image mode. Also, a data stream of a macro block unit corresponding to a 16×16 matrix of the APS array 210 is used for encoding by the MPEG encoder 234 during compression for the moving-image mode.

The MPEG encoder 234 performs moving-image mode encoding using a frame memory 235 which stores previous frame data of a macro block unit. The present invention may be practiced with the frame memory 235 being formed inside or outside the image signal processing apparatus 200. The size of the frame memory 235 is proportional to a maximum resolution of a compressed image.

In this manner, compressed data is generated from the image-processed signals (Y, Cb, Cr) according to the still image mode and the moving-image mode. A multiplexer 236 selects the compressed data from one of the JPEG encoder 233 or the MPEG encoder 234 depending on the selected mode MODE.

If the selected mode MODE indicates the still image mode, the output from the JPEG encoder 233 is selected by the multiplexer 236 and stored in the line memory 237. If the selected mode MODE indicates the moving-image mode, the output from the MPEG encoder 234 is selected by the multiplexer 236 and stored in the line memory 237.

The compressed data is stored in the line memory 237 with a FIFO (First In First Out) order structure. Thus, the compressed data stored within the line memory 237 is output a predetermined number of bytes at a time to the data formatter 250 in such FIFO order.

In an example embodiment of the present invention, the line memory 237 stores compressed data corresponding to a line data size (minimum 256 bytes) of the image-processed signals (Y, Cr, Cb) for a 5:1 compression rate that is a minimum for the still-image mode compression by the JPEG encoder 233. Such a line data size of the image-processed signals (Y, Cb, Cr) is for a row of the APS array 210 to be displayed on a row of pixels on the display device (720 of FIG. 6).

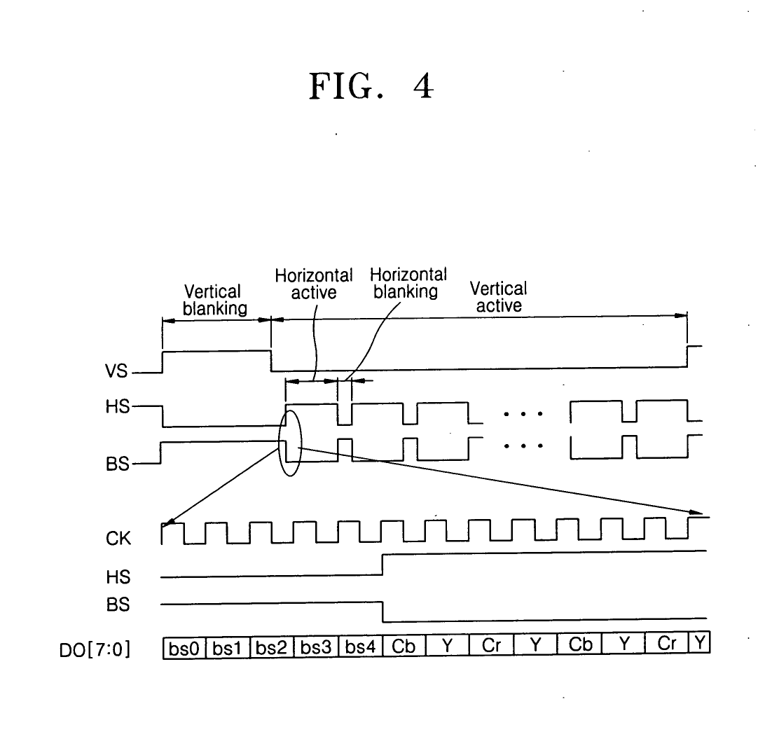

Referring back to FIGS. 2 and 3, the data formatter 250 outputs the compressed data stored in the line memory 237 during blanking intervals of timing signals HS and VS for the display data from the second scaler 240 (step S360 of FIG. 3). FIG. 4 shows a timing diagram of signals for illustrating such output of the compressed data during such blanking intervals.

Referring to FIG. 4, the timing signals corresponding to the display data from the second scaler 240 include the horizontal synchronization signal HS and the vertical synchronization signal VS from the image signal processor 220. In an embodiment of the present invention, the data formatter 250 outputs the display data received from the second scaler 240 in active intervals (horizontal active) of a horizontal synchronization signal HS.

For example, for VGA (Video Graphic Adapter: 640*480) resolution, the active interval (horizontal active) of the horizontal synchronization signal is repeated 480 times during an active interval (vertical active) of the vertical synchronization signal VS. The active interval of the horizontal synchronization signal HS corresponds to 1280 cycles of a system clock (CK), and the blanking interval of the horizontal synchronization signal HS corresponds to 280 cycles of the system clock (CK), for example.

1280 bytes of the display data are output in synchronization with the system clock (CK) during an active interval of the horizontal synchronization signal HS, with each byte corresponding to 8 bits (DO[7:0]) from the data formatter 250. As shown in FIG. 4, the display data is output from the data formatter 250 in an order of . . . , Y. Cb, Y, Cr, Y, Cb, Y, Cr, . . . . At this time, 640 brightness signals Y, 320 chroma signals (Cb), and 320 chroma signals (Cr) are output during the active interval of the horizontal synchronization signal HS.

In addition, the data formatter 250 outputs 280 bytes of the compressed data (such as bs0 through bs4 in FIG. 4) stored in the line memory 237 per 280 cycles of the system clock (CK) during a blanking interval. In particular, the data formatter 250 outputs the compressed data during a blanking interval of the horizontal synchronization signal HS or during a blanking interval of the vertical synchronization signal VS.

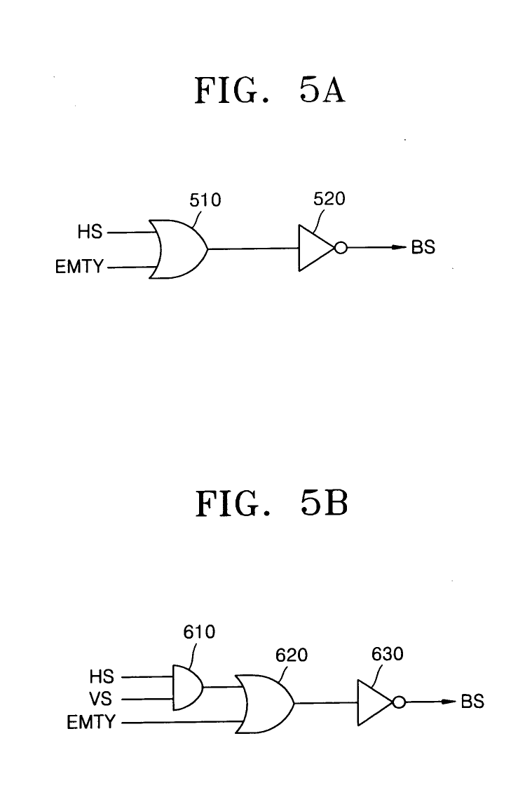

FIG. 5A illustrates a blanking signal generator formed within the data formatter 250 for activating a blanking signal BS to a logical high state during a blanking interval of the horizontal synchronization signal HS using an OR gate 510 and an inverter 520 as illustrated in FIG. 5A. In FIG. 5A, the blanking signal BS is activated to the logical high state when the horizontal synchronization signal HS and an EMTY signal are each at a logical low state. The EMTY (empty) signal is activated to the logical high state when no compression data is stored in the line memory 237 and is at the logical low state when compression data is stored in the line memory 237.

Alternatively, FIG. 5B illustrates a blanking signal generator formed within the data formatter 250 for activating the blanking signal BS during a blanking interval of the horizontal synchronization signal HS or the vertical synchronization signal VS using an AND gate 610, an OR gate 620, and an inverter 630 as illustrated in FIG. 5B. In FIG. 5B, the blanking signal BS is activated to a logic high state if at least one of the horizontal synchronization signal HS and the vertical synchronization signal VS is at a logical low state (i.e., during the corresponding blanking interval) and the EMTY signal is at the logical low state indicating that compressed data is stored in the line memory 237.

In either case of FIGS. 5A and 5B, the data formatter 250 outputs the compressed data from the line memory 237 when the BS signal is activated to the logical high state.

A minimum compression rate for the still image mode is 5:1. Thus, a maximum amount of the compressed data output from the line memory 237 is 1280* (1/5)=256 bytes for each 1280 cycles of the system clock (CK) corresponding to an active interval of the horizontal synchronization signal HS. Accordingly, if the size of the line memory 237 is larger than 256 bytes, data overflow is avoided for compressed data in the still image mode. Since the compression rate for the moving-image mode is greater than the compression rate for the still image mode, such data overflow is also avoided for the moving-image mode.

Referring back to FIG. 3, the data formatter 250 outputs the display data from the second scaler 240 during the active intervals of the horizontal synchronization signal HS and the vertical synchronization signal VS. Such display data from the data formatter 250 drives the display device (720 of FIG. 6).

In addition, the data formatter 250 outputs the compressed data from the line memory 237 during the blanking intervals of the horizontal synchronization signal HS and/or the vertical synchronization signal VS. Such compressed data is photo data capable of being shown on a display device (730 of FIG. 6) and is stored in a memory device (740 of FIG. 6) under control of a predetermined controller (not shown) (step S370 of FIG. 3).

Referring to FIG. 6, the components of the image signal processing apparatus 200 including the solid state image sensing device 210, the image signal processor 220, the data scaler 240 that generates the display data, the data compressor 230 that generates the compressed data, and the data formatter 250 are all fabricated within a single IC die 710. With such compact formation, the image signal processing apparatus 200 may be readily incorporated into small portable electronic devices such as a digital still camera or a camera for a mobile phone.

In addition, the compressed data is output during the blanking intervals of the horizontal synchronization signal HS and/or the vertical synchronization signal VS. Thus, time may be saved with added flexibility for processing both the display data and the compressed data.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of processing at least one image signal, comprising:
generating, from the image signal, display data that is synchronized to at least one timing signal having active intervals and blanking intervals;
generating, from the image signal, compressed data; and
outputting the compressed data during the blanking intervals.

2. The method of claim 1, further comprising:
storing the outputted compressed data in a memory device.

3. The method of claim 1, further comprising:
displaying the outputted compressed data.

4. The method of claim 1, further comprising:
outputting the display data during the active intervals.

5. The method of claim 1, wherein the at least one timing signal includes a horizontal synchronization signal and a vertical synchronization signal, and wherein the compressed data is output during a blanking interval of at least one of the horizontal and vertical synchronization signals.

6. The method of claim 1, further comprising:
generating image-processed signals including a brightness (Y) signal and chroma (Cb, Cr) signals from the image signal; and
generating the compressed data and the display data from the image-processed signals.

7. The method of claim 6, further comprising:
sampling the image-processed signals for generating the display data.

8. The method of claim 6, further comprising:
compressing the image-processed signals according to a selected one of a JPEG or MPEG standard to generate the compressed data.

9. The method of claim 1, further comprising:
storing the compressed data in a line memory;
activating a blanking signal during the blanking intervals; and
outputting the compressed data stored in the line memory when the blanking signal is activated.

10. An apparatus for processing at least one image signal, comprising:
a scaler for generating display data, corresponding to the image signal, that is synchronized to at least one timing signal having active intervals and blanking intervals;
a data compressor for generating compressed data corresponding to the image signal; and
a data formatter, coupled to the scaler and the data compressor, for outputting the compressed data during the blanking intervals.

11. The apparatus of claim 10, wherein the data formatter outputs the display data during the active intervals.

12. The apparatus of claim 10, further comprising:
an image signal processor for generating, from the image signal, image-processed signals including a brightness (Y) signal and chroma (Cb, Cr) signals and for generating a horizontal synchronization signal and a vertical synchronization signal.

13. The apparatus of claim 12, wherein the data formatter outputs the compressed data during a blanking interval of at least one of the horizontal and vertical synchronization signals.

14. The apparatus of claim 12, wherein the scaler generates the display data by sampling the image-processed signals.

15. The apparatus of claim 12, wherein the data compressor includes a JPEG encoder and an MPEG encoder to compress the image-processed signals according to a selected one of a JPEG or MPEG standard to generate the compressed data.

16. The apparatus of claim 10, further comprising:
a line memory for storing the compressed data; and
a blanking signal generator for activating a blanking signal during the blanking intervals;
wherein the data formatter outputs the compressed data stored in the line memory when the blanking signal is activated.

17. An apparatus for processing at least one image signal, comprising:
an IC (integrated circuit) die having fabricated therein:
a scaler for generating display data, corresponding to the image signal, that is synchronized to at least one timing signal having active intervals and blanking intervals;
a data compressor for generating compressed data corresponding to the image signal; and
a data formatter, coupled to the scaler and the data compressor, for outputting the display data and the compressed data.

18. The apparatus of claim 17, wherein the data formatter outputs the display data during the active intervals and outputs the compressed data during the blanking intervals.

19. The apparatus of claim 17, wherein the IC die further has fabricated therein:
an image sensing device for generating the image signal; and
an image signal processor for generating, from the image signal, image-processed signals including a brightness (Y) signal and chroma (Cb, Cr) signals and for generating a horizontal synchronization signal and a vertical synchronization signal,
wherein the data formatter outputs the compressed data during a blanking interval of one of the horizontal and vertical synchronization signals.

20. The apparatus of claim 19, wherein the IC die further has fabricated therein:
a data scaler for generating the display data by sampling the image-processed signals.

21. The apparatus of claim 19, wherein the IC die further has fabricated therein:
a JPEG encoder and an MPEG encoder for compressing the image-processed signals according to a selected one of a JPEG or MPEG standard to generate the compressed data.

22. The apparatus of claim 17, wherein the IC die further has fabricated therein:
a line memory for storing the compressed data; and
a blanking signal generator for activating a blanking signal during the blanking intervals;
wherein the data formatter outputs the compressed data stored in the line memory when the blanking signal is activated.
